(19) United States
(12) Patent Application Publication
(10) Pub. No.: US 2014/0186625 A1
(43) Pub. Date: Jul. 3, 2014

(54) COMPOSITION FOR ACID GAS TOLERANT REMOVAL OF MERCURY FROM A FLUE GAS

(71) Applicant: ADA CARBON SOLUTIONS, LLC, Littleton, CO (US)

(72) Inventors: Joseph M. Wong, Castle Rock, CO (US); Robert B. Huston, Longmont, CO (US); Christopher Vizcaino, Littleton, CO (US); Jacob B. Lowring, Coushatta, LA (US)

(73) Assignee: ADA Carbon Solutions, LLC, Littleton, CO (US)

(21) Appl. No.: 13/730,490

(22) Filed: Dec. 28, 2012

(51) Int. Cl. B01J 20/20; B01D 53/10

(52) U.S. Cl. CPC B01J 20/20; B01D 53/10
USPC 428/402; 252/186.1

(57) ABSTRACT

Method and compositions useful for removal of mercury from a flue gas stream with relatively high concentrations of acid gas precursors and/or acid gases. The method includes contacting the flue gas stream with a multi-functional agent, where the multi-functional agent includes a salt having a cation of valency 3 or higher. A composition comprises a (1) sorbent material such as powdered activated carbon which will ultimately capture and sequester oxidized mercury, (2) a multi-functional agent that protects the sorbent core from unfavorable reaction conditions or inhibitors, oxidizes or helps catalyze the oxidation of elemental mercury, and/or amalgamates with elemental mercury to make it easier to capture, among other benefits, and optionally (3) a halogen such as in the form of a halide salt that helps facilitate the oxidation of elemental mercury into its oxidized form.

### FIELD OF THE INVENTION

This disclosure relates to the field of compositions for the removal of mercury from a fluid stream such as a flue gas stream, particularly a fluid stream which has relatively high concentrations of acid gas precursors and/or acidic gases.

### BACKGROUND OF THE INVENTION

Mercury is well known to be a highly toxic compound. Exposure at appreciable levels can lead to adverse health effects for people of all ages, including harm to the brain, heart, kidneys, lungs, and immune system. Although mercury is naturally occurring, most emissions result from various human activities such as burning fossil fuels and other industrial processes. For example, in the United States about 40% of the mercury introduced into the environment comes from coal-fired power plants.

In the United States and Canada, federal and state/provincial regulations have been implemented or are being considered to reduce mercury emissions, particularly from coal-fired power plants, steel mills, cement kilns, waste incinerators and boilers, industrial coal-fired boilers, and other coal-combusting facilities. For example, the United States Environmental Protection Agency (U.S. EPA) has promulgated Mercury Air Toxics Standards (MATS), which would among other things require coal-fired power plants to capture at least approximately 80% to 90% of their mercury emissions beginning in 2016.

The leading technology for mercury control from coal-fired power plants is activated carbon injection. Activated carbon injection involves the injection of sorbents, particularly powdered activated carbon, into the flue gas emitted by the boiler. This approach is characterized by three primary steps, which may occur sequentially or simultaneously: (1) contact of the injected sorbent with the mercury species, which is typically present in very dilute concentrations in the flue gas (e.g., <100 parts per billion); (2) conversion of elemental mercury (i.e., Hg⁰), which is relatively inert and not easily adsorbed onto the sorbent, into an oxidized mercury species (e.g., Hg⁺ and Hg⁺²), which is readily adsorbable by the sorbent via physisorption (physical capture) or chemisorption (capture by chemical attraction); and (3) the rapid diffusion of the oxidized mercury species into the sorbent pores where it is held tightly (e.g., sequestered) without being released. The sorbent in the flue gas streams traverse the ductwork at very high velocities, such as in excess of 25 feet/second, before being removed by the facility's particulate removal device such as an electrostatic precipitator (ESP) or fabric filter/baghouse. Therefore, once injected, the sorbent must rapidly go through these three steps to contact, oxidize and sequester the relatively dilute amounts of mercury. In some instances, the sorbent only has a residence time of 1 to 2 seconds in the flue gas.

In spite of these challenges, activated carbon injection technology has been demonstrated to effectively control mercury emissions in many coal-fired power plants. However, it has been demonstrated to be less effective in facilities that produce flue gas streams with relatively high concentrations of acid gases such as sulfur oxides (e.g., SO₂ and SO₃), nitrogen oxides (e.g., NO₂ and NO₃) and others. Under conditions of high temperature, moisture, and pressure such as in a flue gas, these acid gases can form acids e.g., sulfuric acid (H₂SO₄) or nitric acid (HNO₃). It is believed that these acids may inhibit or slow the mercury capture mechanism by interfering competitively with the reaction and adsorption sites that would otherwise be used to capture and bind mercury. For example, it has been observed that flue gases with concentrations of SO₃ as low as 3 ppm can detrimentally affect mercury capture rates.

Acid gas precursors and/or acid gases typically come from three primary sources. The first is the coal feedstock fed to the boiler. Certain types of coal inherently have high concentrations of sulfur, nitrogen, chlorine, or other compounds which can form acid gases in the flue gas. For example, coals such as Illinois basin coal with high sulfur content (e.g., above about 0.5%) are becoming more common as a boiler feedstock for economic reasons, as high sulfur coals tend to be cheaper than low sulfur coals. A second source is the selective catalytic reduction (SCR) step for controlling emissions of NOₓ. An unintended consequence of this process is that SO₂ in the flue gas can be oxidized to form SO₃. A third source is that the power plant operator may be injecting SO₃ into the flue gas stream to enhance the efficiency of the particulate removal devices, e.g., to avoid opacity issues and increase the effectiveness of an electrostatic precipitator (ESP) in removing particulates from the flue gas stream. Accordingly, a power plant operator with any of the foregoing (or similar) operating conditions may not be able to practicably use conventional powdered activated carbon products to capture mercury and cost-effectively comply with government regulations such as EPA MATS.

Several technologies have been proposed to address these situations where the presence of acid gas precursors and/or acid gases inhibits mercury capture performance. One such technology is the separate injection of dry alkaline compounds such as trona, calcium oxide, calcium hydroxide, calcium carbonate, magnesium carbonate, magnesium hydroxide, magnesium oxide, sodium bicarbonate, and sodium carbonate into the flue gas to mitigate the acid gases. Aqueous solutions may also be injected into the flue gas stream, including sodium bisulfate, sodium sulfate, sodium carbonate, sodium bicarbonate, sodium hydroxide, or thiosulfate solutions.

Another technology involves the simultaneous injection of activated carbon and an acid gas agent, either as an admixture or with activated carbon treated with the agent. The acid gas agents may include alkaline compounds such as sodium bicarbonate, sodium carbonate, ammonium carbonate, ammonium bicarbonate, potassium carbonate, potassium bicarbonate, trona, magnesium oxide, magnesium hydroxide, calcium oxide, calcium hydroxide, calcium bicarbonate and calcium carbonate.

Another technology involves the co-injection of activated carbon and an acid gas agent where the acid gas agent may include Group 1 (alkali metal) or Group 2 (alkaline earth metal) compounds, or compounds including halides and a non-metal cation such as nitrogen, e.g., ammonium halides, amine halides, and quaternary ammonium halides.

### SUMMARY OF THE INVENTION

Many of the acid gas agents discussed above are hygroscopic, meaning they have an affinity for water, and may cause agglomeration. Thus, the agents may have handling and flowability issues, possibly requiring the addition of hydrophobic flow aids to counter such effects. Such flow aids can be costly, adding to the manufacturing cost and diluting the sorbent composition with material that does not play an active role in the mercury capture mechanism or in the mitigation of acid gases.

Some of the acid gas agents, such as ammonium halide, are more volatile than typical oxidation agents such as Group 1 and Group 2 bromide salts, and the increased volatility may cause accelerated corrosion of plant equipment.

It would be advantageous to provide methods and compositions for the capture of mercury from a flue gas stream with relatively high concentrations of acid gas precursors and/or acid gases such as SO₃ and which also overcomes one or more limitations of the prior art.

In one embodiment, a sorbent composition for the treatment of a flue gas is provided. The sorbent composition includes a sorbent material and a multi-functional agent, the multi-functional agent comprising a salt having a cation that has a valency of 3 or higher, such as a valency of +3 or +4.

In one characterization, the sorbent material is selected from the group consisting of activated carbon, reactivated carbon, carbonaceous char, zeolite, silica, silica gel, alumina clay, or combinations thereof. For example, the sorbent material may be a porous carbonaceous material, such as activated carbon. In another characterization, the sorbent composition includes an admixture of sorbent material particles and multi-functional agent particles. The particle admixture may have a D50 median particle size of not greater than about 30 microns, such as not greater than about 25 microns, not greater than about 20 microns, not greater than about 15 microns, not greater than about 12 microns, not greater than about 10 microns or even not greater than about 8 microns.

The cation of the salt may be a metal cation. For example, the metal cation may be selected from the group consisting of Group 3 to Group 14 metals. In one characterization, the metal cation may be selected from the group consisting of Group 3 to Group 12 metals, or may be selected from the group consisting of Group 13 and Group 14 metals. For example, the metal cation may be a Group 13 metal, and in a particular characterization may be aluminum. In another particular characterization, the metal cation may be tin. The salt may be an inorganic salt, and may include an anion selected from the group consisting of hydroxides, oxides, and carbonates. In one particular characterization, the salt may comprise aluminum hydroxide (Al(OH)₃). In another characterization, the salt may be selected from the group consisting of Tin(IV) oxide (SnO₂) and Tin(IV) hydroxide (Sn(OH)₄).

In another characterization, the multi-functional agent may be coated (e.g., partially coated or completely coated) onto the sorbent material.

The sorbent composition may include an effective amount of the multi-functional agent, such as at least about 2 wt. % of the multi-functional agent, at least about 5 wt. % of the multi-functional agent, at least about 8 wt. % of the multi-functional agent, at least about 10 wt. % of the multi-functional agent, at least about 12 wt. % of the multi-functional agent, at least about 15 wt. % of the multi-functional agent, or even at least about 20 wt. % of the multi-functional agent. In one characterization, the sorbent composition includes not greater than about 50 wt. % of the multi-functional agent.

The sorbent composition may also include a halogen or a halogen-containing compound, such as at least about 1 wt. % and not greater than about 15 wt. % of a halogen or halogen-containing compound. For example, the halogen or halogen-containing component may be a bromide salt.

In another characterization, the sorbent composition loses not greater than about 13% sulfur during a sulfuric acid consumption test, such as not greater than about 10% or even not greater than about 5% sulfur during the sulfuric acid consumption test.

According to another embodiment, a method from removing mercury from a flue gas stream containing acid gas precursors and/or acid gases is provided. The method may include contacting the flue gas stream with: (i) a sorbent material; and (ii) a multi-functional agent comprising a salt having a cation that has a valency of 3 or higher. The contacting step may include contacting the flue gas stream with the multi-functional agent separately from the sorbent material. The contacting step may also include contacting the flue gas stream with the multi-functional agent simultaneously with the sorbent material, such as contacting the flue gas stream with a sorbent composition comprising the multi-functional agent coated (e.g., partially coated or completely coated) onto the sorbent material, or with a sorbent composition comprising an admixture of the multi-functional agent and the sorbent material. In this regard, any of the sorbent compositions summarized above and described in more detail below may be utilized in the method.

The method may include treating a flue gas stream having at least about 3 ppm SO₃, such as at least about 5 ppm SO₃. In one characterization, the flue gas stream is extracted from a boiler burning coal having a sulfur content of at least about 0.5 wt. % of the coal.

### DESCRIPTION OF THE DRAWINGS

FIG. 1 illustrates an exemplary plant configuration and method for the capture and sequestration of mercury from a flue gas stream.

FIG. 2 illustrates an exemplary flow sheet for the manufacture of the composition described herein.

FIG. 3 illustrates the results of the sulfuric acid consumption test comparing the composition described herein with prior art.

### DETAILED DESCRIPTION OF THE INVENTION

Disclosed herein are methods and compositions that are useful for treating a flue gas stream (e.g., from a coal-burning boiler or a waste energy boiler) at a facility with concentrations of acid gas precursors and/or acid gases (e.g., SO₃) that can otherwise render sorbent materials such as conventional powdered activated carbons to be ineffective for the capture and removal of mercury or other heavy metals from the flue gas stream.

In one embodiment, the method includes contacting a flue gas stream with a sorbent material, and with a multi-functional agent that mitigates the detrimental effects of certain acid gases, e.g., that reduces interference by certain acid gases with the mercury capture by the sorbent material.

The multi-functional agent includes a salt, the salt comprising an anion and comprising a cation having a valency (e.g., an oxidation state) of 3 or higher. In one characterization, the multi-functional agent consists essentially of the salt. The agent disclosed herein is referred to as multi-functional because it may be capable of performing multiple functions in the capture of mercury. First, the anion mitigates the effect of certain acid gases and reduces interference by the acid gas with the mercury capture mechanism. Second, the cation may oxidize and/or catalyze the oxidation of elemental mercury, making the mercury more readily captured and sequestered by either physisorption or chemisorption on a sorbent material. Third, under certain operating conditions, certain of these cations (e.g., metals) may amalgamate with the elemental mercury, thus increasing the size of the mercury compound and facilitating capture and sequestration by physisorption. Moreover, the multi-functional agent may have a low affinity for water (e.g., is not hygroscopic), which means it has the potential to be easier to handle than prior art compositions, such as during the process of handling prior to and during injection into a flue gas stream.

The salt may be an organic salt (e.g., comprising an organic cation or anion) or may be an inorganic salt. Further, the cation may be a simple (monoatomic) cation such as a metal, or may be a polyatomic cation. In one characterization, the salt is an inorganic salt of a metal, i.e., comprising a monoatomic metal cation. For example, the metal cation of the inorganic metal salts may be selected from the transition metals (Group 3 to Group 12 metals on the periodic table of elements), or post-transition metals (Group 13 and Group 14). These metals have advantageous properties in comparison to the metals previously utilized for acid gas agents, such as alkali metals (Group 1), alkaline earth metals (Group 2), and Group 15 based salts. For example, metal cations having a valency of 3 or higher (e.g., trivalent or quadrivalent) may facilitate the mercury capture mechanism by (1) oxidizing and/or catalyzing the oxidation of mercury, and/or (2) amalgamating with the mercury to form a larger mercury compound that is easier to sequester. In one characterization, the metal cation is selected from the group of Group 13 metals, and in a particular characterization the metal cation is aluminum (i.e., Al⁺³). In another characterization, the metal cation is selected from the group of Group 14 metals, and in a particular characterization the metal cation is tin (i.e., Sn⁺⁴).

The anion of the inorganic metal salt may be selected from simple anions (e.g., O²⁻) or oxoanions (e.g., CO₃²⁻, OH⁻). In one characterization, the anion is selected from the group of hydroxides, oxides, and carbonates. Thus, particular examples of useful aluminum salts include aluminum hydroxide (Al(OH)₃), aluminum oxide (Al₂O₃), and aluminum carbonate (Al₂(CO₃)₃). In one particular characterization, the salt comprises Al(OH)₃. Particular examples of useful salts also include tin compounds such as Tin(IV) hydroxide (Sn(OH)₄), tin dioxide (SnO₂), and tin carbonate (Sn(CO₃)₂). In one particular characterization, the salt comprises SnO₂.

Known methods for treating flue gas having a relatively high acid gas content, particularly a relatively high sulfur trioxide (SO₃) content, typically utilize compounds having metals or other cations that are monovalent or divalent, meaning there are only one or two anions available to mitigate the acid gas. The salts included in the multi-functional agent described herein advantageously comprise cations that are trivalent or higher (e.g., trivalent or quadrivalent), meaning there is potential for more anions to be available to mitigate acid gas precursors and/or acid gases as compared to known compounds used for such mitigation. Thus, less multi-functional agent may be required as compared to the use of known compositions, which potentially reduces operating expenses.

Further, the salts of the multi-functional agent may have a low affinity for water so that the agent does not readily attract and absorb moisture, meaning that the agent may be easier to handle (e.g., to handle, transport and inject into the gas flue stream) than other agents such as alkali metal or alkaline earth metal salts. Alkali metal salts and alkaline earth metal salts tend to associate with water in the presence of moisture (e.g., in high humidity environment) causing agglomeration of the salts. In contrast, the salts disclosed herein may have a lower affinity for water and therefore will not tend to agglomerate.

In one embodiment, the method for removing mercury from a flue gas stream may include contacting the multi-functional agent with the flue gas stream, either separate from the sorbent material or with the sorbent material. In one characterization, the multi-functional agent may be separately injected into the flue gas stream, such as by being injected upstream of the injection of the sorbent. In this regard, the multi-functional agent may be injected into the flue gas stream as a dry powder or in a solution or liquid suspension, such as in an aqueous solution. In one particular characterization, the multi-functional agent is contacted with (e.g., injected into) the flue gas stream as a dry powder.

In another embodiment, the multi-functional agent is contacted with the flue gas stream simultaneously with the sorbent, such as in the form of an admixture with the sorbent material and/or where the sorbent material is treated with the multi-functional agent. For example, the sorbent material may be coated (e.g., partially coated or completely coated) with the multi-functional agent.

In this regard, the sorbent composition for treating a flue gas should include a sufficient amount of the multi-functional agent to at least partially mitigate the effects of acid gases and/or acid gas precursors, particularly of SO₃, on the capture of mercury. In one aspect, the sorbent composition may comprise at least about 2 wt. % of the multi-functional agent, such as at least about 5 wt. %, at least about 8 wt. %, at least about 10 wt. % or even at least about 12 wt. % or 15 wt. % of the multi-functional agent. In some characterizations, the sorbent composition may comprise at least 20 wt. %, 25 wt. % or even 30 wt. % of the multi-functional agent. However, if the multi-functional acid gas agent comprises much greater than about 60 wt. % of the sorbent composition, then the sorbent composition's ability to capture mercury may be adversely affected due to the reduced amount of sorbent material. As such, in one aspect, the sorbent composition comprises not greater than about 50 wt. % of the multi-functional agent. In one particular characterization, the sorbent composition includes at least about 10 wt. % and not greater than about 20 wt. % of the multi-functional agent.

The sorbent material is a porous sorbent material which has the primary function of capturing and sequestering oxidized mercury. The sorbent material can be comprised of any material with a high surface area and with an adequate pore structure, including, but not limited to, activated carbon, reactivated carbon, carbonaceous char, zeolite, silica, silica gel, alumina, clay or any combination thereof. In one particular characterization, the sorbent material comprises a porous carbonaceous material such as activated carbon.

The sorbent composition may or may not also include a halogen (e.g., in the form of a halide salt such as bromide salt). Halogens by themselves are not known to be oxidants for mercury, but are a vital reaction participant in the oxidation of mercury. Significantly increased amounts of the halogen may be detrimental to mercury capture and sequestration, and also can contribute to equipment corrosion and excessive bromine emissions in downstream liquid and gas streams, which may require further treatment processes. In light of the foregoing, the sorbent composition may advantageously include no halogen or halogen-containing compound. Alternatively, the sorbent composition may include at least 1 wt. % and not greater than about 15 wt. % of a halogen or a halogen-containing compound, such as not greater than about 6 wt. %.

The particle size (i.e., median particle size, also known in the art as D₅₀ measured on a volume basis) of the sorbent composition may also be well-controlled. It is believed that generally, smaller particle sizes of both the sorbent material and the multi-functional agent may enhance mercury capture performance, but too small of a particle size may inhibit flowability and material handling or create opacity issues for a coal-fired facility's particulate removal device. Thus, the optimal particle size may depend on the specific operating conditions at the point of end-use. Thus, the sorbent composition may have a D50 of at least about 6 μm and not greater than about 30 μm, such as not greater than about 25 μm, not greater than about 20 μm, not greater than about 15 μm, not greater than about 12 μm, not greater than about 10 μm, or even not greater than about 8 μm. The D₅₀ median particle size may be measured using techniques such as laser light scattering techniques (e.g., using a Saturn DigiSizer II, available from Micromeritics Instrument Corporation, Norcross, Ga.

The sorbent composition may comprise an admixture of sorbent material particles (e.g., activated carbon particles) and multi-functional agent particles. That is, the components may be blended to form a substantially dry homogenous admixture with relatively low moisture content. In another characterization, the sorbent material particle may be coated (e.g., partially coated or completely coated) with the multi-functional agent.

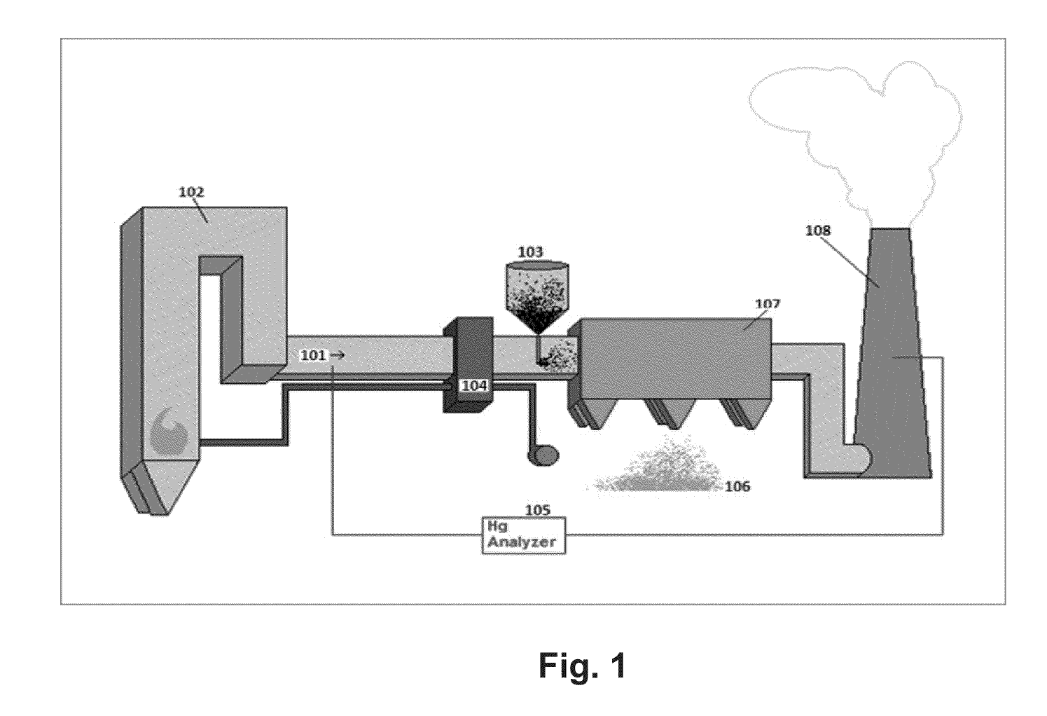

FIG. 1 illustrates one embodiment of a system and method for removal of mercury from a flue gas stream with a high acid gas concentration produced by a coal-burning power plant using the injection of a sorbent composition into the flue gas stream. The flue gas stream 101 exits a boiler 102 where coal has been combusted. The flue gas stream 101 may then proceed to an air heater unit 104 where the temperature of the flue gas stream is reduced. Thereafter, the flue gas stream may be introduced to a separation unit 107 such as an ESP or a fabric filter which removes particulate matter 106 (including the sorbent composition) from the flue gas, before exiting out a stack 108. For example, a cold-side (i.e., after the air heater unit) ESP can be used. In order to capture mercury from the flue gas, the sorbent composition may be introduced (e.g., injected into) to the flue gas stream after 103 the air heater unit 104, but before the separation unit 107 which will remove the sorbent composition 106 from the flue gas. The mercury concentration in the flue gas may be measured using one or more mercury analyzers 105. It will be appreciated by those skilled in the art that the plant may include other devices not illustrated in FIG. 1, such as a selective catalytic reduction unit (SCR) and the like, and may have numerous other configurations.

In an alternative arrangement, as is discussed above, the multi-functional agent may be contacted with the flue gas stream separately from the sorbent material. For example, the multi-functional agent may be injected as a dry powder either before the air heater unit 104 or after the air heater unit 104. In one particular characterization, the multi-functional agent is injected into the flue gas stream 101 either upstream from the sorbent material or substantially simultaneously with the sorbent material, e.g., through a separate injection port.

The flue gas stream 101 may include acid gases and/or acid gas precursors. In one characterization, the flue gas stream comprises sulfur trioxide (SO₃). For example, the flue gas stream may include at least about 3 ppm SO₃, such as at least about 5 ppm SO₃ or even 10 ppm or higher. Sulfur trioxide may originate from the feedstock (e.g., coal) that is combusted in the boiler. For example, the feedstock combusted in the boiler may have a sulfur content of at least about 0.5 wt. %. Alternatively, or in addition to a feedstock having relatively high sulfur content, at least some of the SO₃ may be purposefully added to the flue gas stream, such as to enhance the efficiency of the particulate removal device. In any event, the flue gas stream may include elevated levels of SO₃ at some point during its traversal though the system.

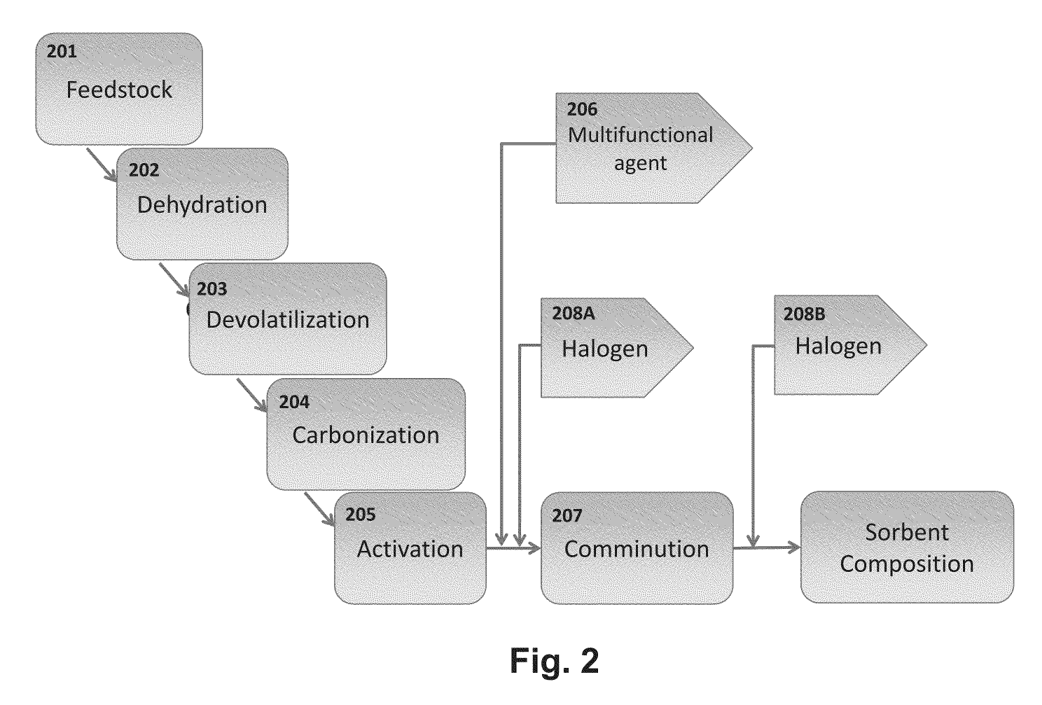

FIG. 2 is a flow sheet that illustrates an exemplary method for the manufacture of a sorbent composition in accordance with one embodiment that includes at least a sorbent material and a multi-functional agent. The manufacturing process begins with a carbonaceous feedstock 201 such as lignite coal. In the manufacturing process, the feedstock is subjected to an elevated temperature and one or more oxidizing gases under exothermic conditions for a period of time to sufficiently increase surface area, create porosity, and/or alter surface chemistry. The specific steps in the process include: (1) dehydration 202, where the feedstock is heated to remove the free and bound water, typically occurring at temperatures ranging from 100° C. to 150° C.; (2) devolatilization 203, where free and weakly bound volatile organic constituents are removed, typically occurring at temperatures above 150° C.; (3) carbonization 204, where non-carbon elements continue to be removed and elemental carbon is concentrated and transformed into random amorphous structures, typically occurring at temperatures around the 350° C. to 800° C.; and (4) activation 205, where steam, air or other oxidizing agent is added and pores are developed, typically occurring at temperatures above 800° C. The manufacturing process may be carried out, for example, in a multi-hearth or rotary furnace. The manufacturing process is not discrete and steps can overlap and use various temperatures, gases and residence times within the ranges of each step to promote desired surface chemistry and physical characteristics of the manufactured product.

After activation 205, the product is admixed with the multi-functional agent(s) 206, with the desired weight percentage. The admixture may be subjected to one or more or more comminution step(s) 207 to mill the admixture to the desired particle size. Comminution 207 may occur, for example, in one or more mills such as a roll mill, jet mill or other like process.

A halogen may be added to the admixture at any stage after the mixing process. For example, as illustrated in FIG. 2, halogen may be introduced either before 208A or after 208B comminution. The halogen may be introduced as a dry or wet halide salt.

### EXAMPLES

The sulfuric acid consumption test is a way to measure the ability of a sorbent to withstand the presence of sulfuric acid, and is a meaningful way to determine the efficacy of an agent for acid gas mitigation. To perform the test, the first step is to obtain a 1,000 mg sample of the composition to be tested. Half (500 mg) is used as a control to measure the pre-test sulfur content using a S632 Sulfur Analyzer, from LECO Corporation of St. Joseph, Mich. The next steps are to put the remaining 500 mg sample in an Erlenmeyer flask, add 50 mL of a 10 ppm solution of sulfuric acid, stopper and shake for about 1 minute, vacuum-filter the slurry, and dry the sample captured on the filter in a convection oven for 2 hours at 150° C. After the sample is dried and returns to room temperature, the final step is to measure the sulfur content and compare to the pre-test measurement. It is believed that the sulfuric acid solution would react with sulfur bound to the sorbent, and the post-test sample would contain less sulfur than the pre-test measurement. In sorbents that have been treated, an effective treatment will yield a smaller difference in sulfur content, meaning the adverse impacts of the acid solution have been effectively mitigated.

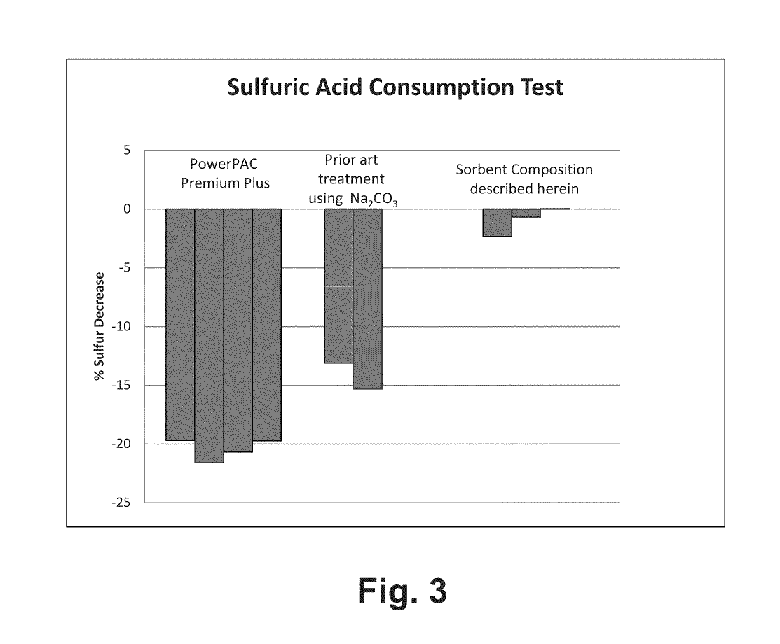

FIG. 3 summarizes the results of testing on: (1) a conventional untreated activated carbon product, namely PowerPAC Premium Plus™ manufactured by ADA Carbon Solutions, LLC, of Littleton, Colo., which has a D50 of about 25 microns and comprises approximately 5.5 wt. % bromide salt, (2) a prior art treatment which has a D50 of 8 to 12 microns, and comprises approximately 5.5 wt. % bromide salt and approximately 10 wt. % sodium carbonate, and (3) an embodiment of the composition described herein which has a D50 of 8 to 12 microns, and comprises approximately 5.5 wt. % bromide salt and approximately 10 wt. % aluminum hydroxide. The baseline, as demonstrated by the conventional untreated product, is approximately a −20% difference in sulfur content. The sample of the prior art treatment using sodium carbonate shows approximately a −14% difference in sulfur content. By contrast, for the sample of the composition described herein shows a difference in sulfur content of approximately 0% to 2%, indicating that this sample showed very little change in sulfur content due to the presence of sulfuric acid.

While various embodiments of the present invention have been described in detail, it is apparent that modifications and adaptations of those embodiments will occur to those skilled in the art. However, is to be expressly understood that such modifications and adaptations are within the spirit and scope of the present invention.

1. A sorbent composition for the treatment of a flue gas, the sorbent composition comprising a sorbent material and a multi-functional agent, the multi-functional agent comprising a salt having a cation that has a valency of 3 or higher.

2. The sorbent composition of claim 1, where the sorbent material comprises a porous carbonaceous material.

3. The sorbent composition of claim 1, wherein the sorbent composition comprises an admixture of sorbent material particles and multi-functional agent particles.

4. The sorbent composition of claim 3, where the particle admixture has a D50 median particle size of not greater than about 30 microns.

5. The sorbent composition of claim 3, where the particle admixture has a D50 median particle size of not greater than about 25 microns.

6. The sorbent composition of claim 3, where the particle admixture has a D50 median particle size of not greater than about 20 microns.

7. The sorbent composition of claim 3, where the particle admixture has a D50 median particle size of not greater than about 15 microns.

8. The sorbent composition of claim 3, where the particle admixture has a D50 median particle size of not greater than about 12 microns.

9. The sorbent composition of claim 3, where the particle admixture has a D50 median particle size of not greater than about 10 microns.

10. The sorbent composition of claim 3, where the particle admixture has a D50 median particle size of not greater than about 8 microns.

11. The sorbent composition of claim 1, wherein the sorbent material is selected from the group consisting of activated carbon, reactivated carbon, carbonaceous char, zeolite, silica, silica gel, alumina clay, or combinations thereof.

12. The sorbent composition of claim 1, wherein the cation is a metal cation.

13. The sorbent composition of claim 12, wherein the metal cation is selected from the group consisting of Group 3 to Group 14 metals.

14. The sorbent composition of claim 12, wherein the metal cation is selected from the group consisting of Group 3 to Group 12 metals.

15. The sorbent composition of claim 12, wherein the metal cation is selected from the group consisting of Group 13 and Group 14 metals.

16. The sorbent composition of claim 15, wherein the metal cation is a Group 13 metal.

17. The sorbent composition of claim 16, wherein the metal cation is aluminum.

18. The sorbent composition of claim 15, wherein the metal cation is tin.

19. The sorbent composition of claim 12, wherein the salt is an inorganic salt.

20. The sorbent composition of claim 12, wherein the salt comprises an anion selected from the group consisting of hydroxides, oxides, and carbonates.

21. The sorbent composition of claim 20, wherein salt comprises aluminum hydroxide (Al(OH)₃).

22. The sorbent composition of claim 20, wherein the salt is selected from the group consisting of Tin(IV) oxide (SnO₂) and Tin(IV) hydroxide (Sn(OH)₄).

23. The sorbent composition of claim 1, wherein the multi-functional agent is coated or partly coated onto the sorbent material.

24. The sorbent composition of claim 1, wherein the sorbent composition comprises at least about 2 wt. % of the multi-functional agent.

25. The sorbent composition of claim 1, wherein the sorbent composition comprises at least about 5 wt. % of the multi-functional agent.

26. The sorbent composition of claim 1, wherein the sorbent composition comprises at least about 8 wt. % of the multi-functional agent.

27. The sorbent composition of claim 1, wherein the sorbent composition comprises at least about 10 wt. % of the multi-functional agent.

28. The sorbent composition of claim 1, wherein the sorbent composition comprises at least about 12 wt. % of the multi-functional agent.

29. The sorbent composition of claim 1, wherein the sorbent composition comprises at least about 15 wt. % of the multi-functional agent.

30. The sorbent composition of claim 1, wherein the sorbent composition comprises at least about 20 wt. % of the multi-functional agent.

31. The sorbent composition of claim 1, wherein the sorbent composition comprises not greater than about 50 wt. % of the multi-functional agent.

32. The sorbent composition of claim 1, wherein the sorbent composition comprises at least about 1 wt. % and not greater than about 15 wt. % of a halogen or halogen-containing compound.

33. The sorbent composition of claim 32, wherein the halogen or halogen-containing component comprises a bromide salt.

34. The sorbent composition of claim 1, wherein the sorbent composition loses not greater than about 13% sulfur during the sulfuric acid consumption test.

35. The sorbent composition of claim 1, wherein the sorbent composition loses not greater than about 10% sulfur during the sulfuric acid consumption test.

36. The sorbent composition of claim 1, wherein the sorbent composition loses not greater than about 5% sulfur during the sulfuric acid consumption test.

37. A sorbent composition for the treatment of a flue gas, the sorbent composition comprising a porous carbonaceous sorbent material and at least about 2 wt. % of a multi-functional agent, the multi-functional agent comprising an inorganic metal salt having a metal cation selected from Group 13 and Group 14 metals.

38. The sorbent composition of claim 37, wherein the metal cation is selected from Al⁺³ and Sn⁺⁴.

39. The sorbent composition of claim 37, wherein the metal salt is selected from the group consisting of Al(OH)₃, SnO₂ and Sn(OH)₄.

40.-77. (canceled)
